(19) United States
(12) Patent Application Publication
(10) Pub. No.: US 2014/0234539 A1
(43) Pub. Date: Aug. 21, 2014

(54) DIE-TYPE COATING DEVICE AND COATING METHOD

(71) Applicant: NITTO DENKO CORPORATION, Ibaraki-shi, Osaka (JP)

(72) Inventors: Yoshiaki Kitani, Ibaraki-shi (JP); Satoru Saki, Ibaraki-shi (JP); Yoshihiro Kitamura, Ibaraki-shi (JP); Isao Hirose, Ibaraki-shi (JP); Hiroshi Matsuo, Ibaraki-shi (JP); Tetsuo Nasu, Ibaraki-shi (JP)

(73) Assignee: NITTO DENKO CORPORATION, Ibaraki-shi, Osaka (JP)

(21) Appl. No.: 14/343,885

(22) PCT Filed: Feb. 4, 2013
(86) PCT No.: PCT/JP2013/052471

§ 371 Date: Mar. 10, 2014

(30) Foreign Application Priority Data
Feb. 14, 2012 (JP) 2012-029439
Feb. 1, 2013 (JP) 2013-018840

(51) Int. Cl. B05C 1/08; B05D 1/00

(52) U.S. Cl. CPC B05C 1/0886; B05D 1/00
USPC 427/177; 118/712

(57) ABSTRACT

A die-type coating device includes a supply roll, a die, a rewinding roll, web widthwise end position detection devices, and layer widthwise end position detection devices. The die includes a pair of inner deckles which adjust a coating width. The inner deckle is arranged at one of two end portions of the die and configured to be easily moved in the die in a longitudinal direction of the die. The die includes a drive device which drives and moves the inner deckles. The drive device is driven on a basis of information on both widthwise end positions of the web detected by the web widthwise end position detection devices and information on both widthwise end positions of the layer of the coating liquid or the coating layer detected by the layer widthwise end position detection devices so that respective positions of the inner deckles relative to the die are changed.

### CROSS REFERENCE TO RELATED APPLICATIONS

This application claims the benefit of Japanese Patent Application No. 2012-029439, filed Feb. 14, 2012, and Japanese Patent Application No. 2013-018840, filed Feb. 1, 2013, which are hereby incorporated by reference in its entirety.

The present disclosure relates to a die-type coating device and a die-type coating method. With the foregoing device and method, even if a continuously running, long belt-shaped web is meandered etc. and conveyed at a position displaced from the normal conveyance position, both widthwise end positions of a coating liquid layer or a coating layer formed on the surface of the web can be quickly corrected to have a desired position relative to both widthwise end positions of the web. When a workpiece is changed to a web having a different width to form a coating layer, the coating width can be easily adjusted with respect to the web width without the die having to be disassembled.

### BACKGROUND

Examples of conventional coating devices that form a coating layer on the surface of a continuously running, long belt-shaped web include a slot die coating device disclosed in JP Patent Appl. Publ. No. 2004-305955.

The slot die coating device disclosed in JP Patent Appl. Publ. No. 2004-305955 includes a slot die provided with a slot for supplying a coating liquid to a substrate to be coated. The slot faces the substrate to be coated. The cross-section of the slot facing the substrate to be coated has a shape in which the supply of the coating liquid is relatively controlled at both end portions thereof. Specifically, one or more shims having a side surface which has been taper-processed etc. are placed parallel to the outlet direction of the slot.

However, when such a slot die coating device forms a coating layer subsequent to changing a workpiece to a web having a different width, an operator is required to disassemble the die to replace the currently placed shim with another shim having a size corresponding to the coating width. Therefore, there is a problem in terms of workability and working environment. In addition, because of the configuration of the device, it is difficult to correct both widthwise end positions of the coating liquid layer or the coating layer formed on the surface of the web to have a desired position relative to both widthwise end positions of the web when a continuously running, long belt-shaped web is conveyed at a position displaced from the normal conveyance position.

Further, JP Patent Appl. Publ. No. 2004-8975 discloses a coating device in which each of inner deckles is attached to one of the end portions of a die and is moved in the die in the longitudinal direction of the die. The discharge position and width of a coating liquid are optionally changed and the supply amount of the coating liquid is controlled so that the coating liquid can be continuously or intermittently applied to the workpiece and that the shape of the coating on the workpiece can be formed optionally.

However, the coating device disclosed in JP Patent Appl. Publ. No. 2004-8975 stores in a controlling means a mathematical formula in which the shape of the coating formed of the coating liquid is defined by the discharge position and width of the coating liquid with respect to the travel distance of the workpiece. The inner deckles are moved merely on the basis of this mathematical formula. Therefore, when the continuously running, long belt-shaped web is practically conveyed at a position displaced from the normal conveyance position, it is difficult to accurately correct both widthwise end positions of the coating liquid layer or the coating layer to have a desired position relative to both widthwise end positions of the web. One reason is not employing a configuration for directly detecting both widthwise end positions of the coating liquid layer or the coating layer formed on the surface of the web or both widthwise end positions of the web.

### SUMMARY

### Problem to be Solved

It is an object of the present disclosure to provide a die-type coating device and a die-type coating method characterized in that: inner deckles, each of which is arranged at one of the two end portions of a die, are configured to be easily moved in the die in the longitudinal direction of the die; predetermined detection means are arranged upstream and downstream of the die, respectively, in the conveyance direction of a web; thereby, even if a continuously running, long belt-shaped web is conveyed at a position displaced from the normal conveyance position, both widthwise end positions of the coating liquid layer or the coating layer formed on the surface of the web are quickly corrected to have a desired position relative to both widthwise end positions of the web; and even if a workpiece is changed to a web having a different width to form a coating layer, the coating width can be easily adjusted with respect to the web width without the die having to be disassembled.

### Means for Solving the Problem

The gist and the configuration of the present disclosure for attaining the above-specified object are as follows:

(1) A die-type coating device, comprising:

a supply roll which continuously conveys a long belt-shaped web;

a die which discharges and thereby applies a coating liquid to at least one surface of the web conveyed from the supply roll;

a rewinding roll which rewinds the web after a layer of the coating liquid discharged and thereby applied to the web is dried and turned into a coating layer;

web widthwise end position detection means which are arranged upstream of the die in a conveyance direction of the web to detect both widthwise end positions of the web; and

layer widthwise end position detection means which are arranged downstream of the die in the conveyance direction of the web to detect both widthwise end positions of the layer of the coating liquid or the coating layer on the web,

the die including:

a pair of inner deckles which adjust a coating width, wherein the inner deckle is arranged at each of two end portions of the die and configured to be easily moved in the die in a longitudinal direction of the die; and

a drive means which drives and thereby moves the inner deckle,

wherein

the drive means is driven on the basis of information on the both widthwise end positions of the web detected by the web widthwise end position detection means and information on the both widthwise end positions of the layer of the coating liquid or the coating layer detected by the layer widthwise end position detection means so that respective positions of the inner deckles relative to the die are changed.

(2) The die-type coating device according to (1) above, wherein

the die further includes a die piece formed by combining a pair of split die piece members, and the die is formed with a manifold extending in a longitudinal direction of the die piece and a slit extending from the manifold radially outward toward a direction of the die piece,

the inner deckle includes a shaft-shaped deckle main body having an outer surface shape corresponding to a shape of the manifold and a sheet- or film-shaped deckle auxiliary portion which extends from the deckle main body and has an outer surface shape corresponding to a shape of the slit,

the deckle main body includes, in at least a part of a region where the deckle auxiliary portion is arranged, a seal reinforcing portion for reinforcing liquid-tight sealing of a liquid material for coating or extrusion, wherein the liquid material is supplied into the manifold, and

the seal reinforcing portion includes at least one sealing member including two or more films; the films slide and are simultaneously elastically deformed against an inner wall of the manifold when a position of the inner deckle is moved with respect to the die; and the films cooperate with each other and are closely adhered to the inner wall by an elastic restoring force when the position of the inner deckle is fixed with respect to the die.

(3) The die-type coating device according to (1) above, wherein the film constituting the sealing member has an outer diameter larger than a manifold diameter (rc).

(4) The die-type coating device according to (1) above, wherein an outer diameter (rb) of the film constituting the sealing member is larger than the manifold diameter (rc) by 0.01 to 1 mm.

(5) The die-type coating device according to (1) above, wherein each sealing member further includes, between the films, a first spacer member having an outer diameter (rs) smaller than the manifold diameter (rc).

(6) The die-type coating device according to (1) above, wherein the outer diameter (rs) of the first spacer member is smaller than the manifold diameter (rc) by 0.001 to 3 mm.

(7) The die-type coating device according to (1) above, wherein a thickness ts of the first spacer member satisfies an equation below:

ts<(rb−rs)

where:

rs denotes the outer diameter of the first spacer member; and

rb denotes the outer diameter of the film.

(8) The die-type coating device according to (1) above, wherein the seal reinforcing portion includes at least two sealing members and further includes, between the sealing members, a second spacer member having an outer diameter (ra) smaller than the manifold diameter (rc).

(9) The die-type coating device according to (1) above, wherein the outer diameter (ra) of the second spacer member is smaller than the manifold diameter by 0.001 to 3 mm.

(10) The die-type coating device according to (1) above, wherein the seal reinforcing portion is formed on the front end side area of the inner deckle within a region where the deckle auxiliary portion is arranged.

(11) The die-type coating device according to (1) above, wherein the number of films constituting each sealing member is two.

(12) The die-type coating device according to (1) above, wherein the film is made of a lubricating resin material.

(13) A die-type coating method comprising the steps of:

continuously conveying a long belt-shaped web from a supply roll;

discharging and thereby applying a coating liquid by means of a die to at least one surface of the web conveyed; and

rewinding the web by means of a rewinding roll after a layer of the coating liquid discharged and thereby applied to the web is dried and turned into a coating layer;

detecting both widthwise end positions of the web by means of web widthwise end position detection means arranged upstream of the die in a conveyance direction of the web; and

detecting both widthwise end positions of the layer of the coating liquid or the coating layer on the web by means of a layer widthwise end position detection means arranged downstream of the die in the conveyance direction of the web,

the die including:

a pair of inner deckles which adjust a coating width, wherein each of the inner deckles is arranged at one of two end portions of the die and configured to be easily moved in the die in a longitudinal direction of the die; and

a drive means which drives and thereby moves the inner deckle,

wherein

the drive means is driven on the basis of information on the both widthwise end positions of the web detected by the web widthwise end position detection means and information on the both widthwise end positions of the layer of the coating liquid or the coating layer detected by the layer widthwise end position detection means so that respective positions of the inner deckles relative to the die are changed.

### Advantage

According to the present disclosure, it has become possible to provide a die-type coating device and a die-type coating method characterized in that: inner deckles, each of which is arranged at one of the two end portions of a die, are configured to be easily moved in the die in the longitudinal direction of the die; predetermined detection means are arranged upstream and downstream of the die, respectively, in the conveyance direction of a web; thereby, even if a continuously running, long belt-shaped web is conveyed at a position displaced from the normal conveyance position, both widthwise end positions of the coating liquid layer or the coating layer formed on the surface of the web are quickly corrected to have a desired position relative to both widthwise end positions of the web; and furthermore even if a workpiece is changed to a web having a different width to form a coating layer, the coating width can be easily adjusted with respect to the web width without the die having to be disassembled.

### BRIEF DESCRIPTION OF THE DRAWINGS

FIG. 1 is a schematic perspective view illustrating a configuration of a main portion of a representative die-type coating device according to the present disclosure.

FIG. 2 is a perspective view illustrating a state of a representative inner deckle constituting a die-type coating device according to the present disclosure before being attached to a die.

FIG. 3 is a perspective view illustrating a state of the inner deckle shown in FIG. 2 after being attached to a die.

FIG. 4 is an enlarged perspective view of the inner deckle shown in FIG. 2.

FIG. 5 is an enlarged perspective view of a part of an inner deckle in region X of FIG. 4.

FIG. 6 is an explanatory view of dimensions of a spacer member and a sealing member, both of which constitute the seal reinforcing portion shown in FIG. 4.

FIG. 7 is an explanatory view of a sealing member constituting a seal reinforcing portion according to another embodiment.

FIG. 8 is an explanatory view of a sealing member constituting a seal reinforcing portion according to another embodiment.

FIG. 9 is an explanatory view of a sealing member constituting a seal reinforcing portion according to another embodiment.

FIG. 10 is an explanatory view of a sealing member constituting a seal reinforcing portion according to another embodiment.

### DETAILED DESCRIPTION

Next, an embodiment of the present disclosure will be described below with reference to the drawings.

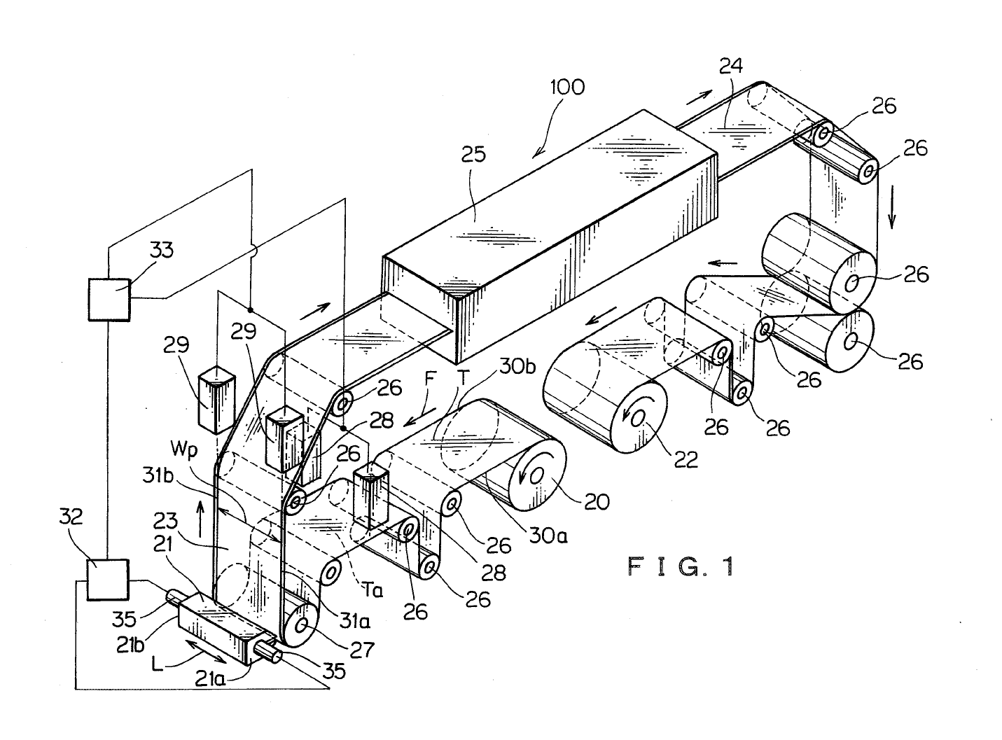

FIG. 1 is a schematic perspective view illustrating a configuration of a main portion of a representative die-type coating device according to the present disclosure.

A die-type coating device 100 shown in FIG. 1 mainly includes a supply roll 20, a die 21, and a rewinding roll 22.

The supply roll 20 is arranged to continuously convey a long belt-shaped web T. In a conveyance stop state before coating, the web T is helically wound in a roll shape. Examples of the web T include plastic films, paper, and metal foils.

The die 21 is so arranged that a coating liquid is discharged onto at least one surface of the web T conveyed from the supply roll 20—i.e, one surface Ta of the web T in FIG. 1—over a predetermined coating width Wp, so as to form a coating liquid layer 23.

The rewinding roll 22 rewinds the web T after the coating liquid layer 23 formed on the web T is dried and turned into a coating layer 24 by means, for example, of a drying device 25.

FIG. 1 shows an embodiment of drying the coating liquid layer 23 in a short amount of time in which the web T applied with the coating liquid layer 23 is allowed to continuously pass inside the drying device 25, such as a hot air drying machine or an infrared ray drying machine. However, the arrangement of the drying device 25 is not necessarily required. As long as the coating liquid layer 23 can be dried in a continuous line by means of natural drying in the air, there is no particular limitation with regard to an embodiment for drying the coating liquid layer 23.

Further, in FIG. 1, a plurality of guide rollers 26 etc. are arranged between the supply roll 20 and the die 21 and between the die 21 and the rewinding roll 22 in order to adjust etc. the conveyance speed of the web I and the tensile force applied to the web T. In addition, a back-up roller 27 is disposed at a position opposite to the die 21 across the web T. The back-up roller 27 can be properly arranged, as necessary.

A main structural feature of the present disclosure is that the inner deckles 35, each of which is arranged at one of two end portions 21a and 21b of the die 21, are configured to be easily moved in the die 21 in a longitudinal direction L of the die 21. Predetermined detection means 28 and 29 are arranged upstream and downstream of the die 21, respectively, in the conveyance direction F of the web T. More specifically, the coating device 100 further includes web widthwise end position detection means and layer widthwise end position detection means 29. The web widthwise end position detection means are a pair of web widthwise end position detection means 28 and 28 in FIG. 1, which are arranged upstream of the die 21 in the conveyance direction F of the web T and detect both widthwise end positions 30a and 30b of the web T. The layer widthwise end position detection means are a pair of layer widthwise end position detection means 29 in FIG. 1, which are arranged downstream of the die 21 and detect both widthwise end positions 31a and 31b of the coating liquid layer 23 or the coating layer 24 on the web T. The die 21 includes a pair of inner deckles 35 for adjusting the coating width Wp, and a drive means 32 for driving and thereby moving the inner deckles 35. The inner deckles 35, each of which is arranged at one of two end portions 21a and 21b of the die 21, facilitate movement of the die 21 in the longitudinal direction L of the die 21. The drive means 32 is driven on the basis of information on both widthwise end positions of the web T detected by the web widthwise end position detection means 28 and information on both widthwise end positions of the coating liquid layer 23 or the coating layer 24 detected by the layer widthwise end position detection means 29. The respective positions of the inner deckles 35 relative to the die 21 are thereby changed.

The method illustrated in FIG. 1 is an example method of driving the drive means 32 on the basis of information on both widthwise end positions of the web T detected by the web widthwise end position detection means 28 and information on both widthwise end positions of the coating liquid layer 23 or the coating layer 24 detected by the layer widthwise end position detection means 29. As illustrated in FIG. 1, a configuration that should be adopted is where the web widthwise end position detection means 28, the layer widthwise end position detection means 29, and the drive means 32 cooperate with each other. For example, the web widthwise end position detection means 28, the layer widthwise end position detection means 29, and the drive means 32 are connected to a control device 33 of a computer etc., and the control means 33 is used to drive the drive means 32 on the basis of the positional information from the web widthwise end position detection means 28 and the layer widthwise end position detection means 29.

Examples of the web widthwise end position detection means 28 and the layer widthwise end position detection means 29 include an ultrasonic sensor and a CCD camera. FIG. 1 shows that the layer widthwise end position detection means 29 are arranged at positions where the widthwise end positions of the coating liquid layer 23 can be measured. However, it is also possible to arrange the layer widthwise end position detection means 29 at a further downstream location where the widthwise end positions of the coating layer 24 can be measured.

The drive means 32 includes, for example, an output shaft coupled to an end of the inner deckle and a motor that rotates the output shaft forward and backward. With this configuration, the forward rotation of the output shaft causes the output shaft and the inner deckles to move forward to a central portion in the longitudinal direction of the die. The backward rotation of the output shaft causes the output shaft and the inner deckles to move backward from the central portion to an end portion in the longitudinal direction of the die.

Next, a die and an inner deckle, both of which constitute a die-type coating device according to an embodiment of the present disclosure, will be described below.

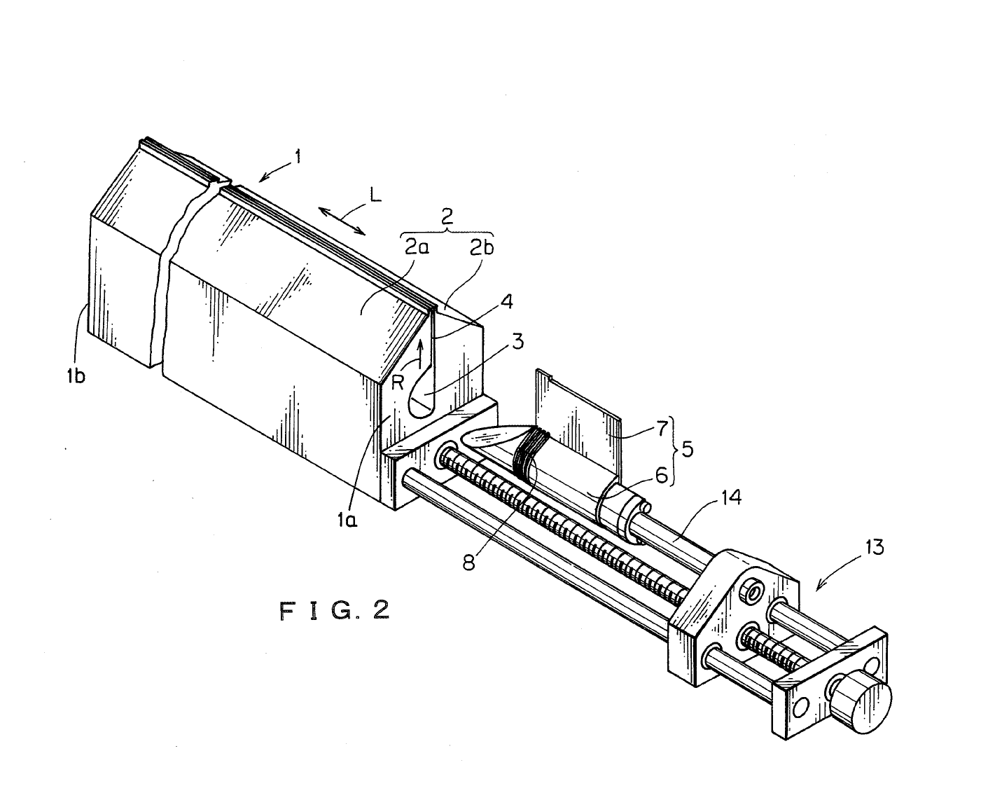

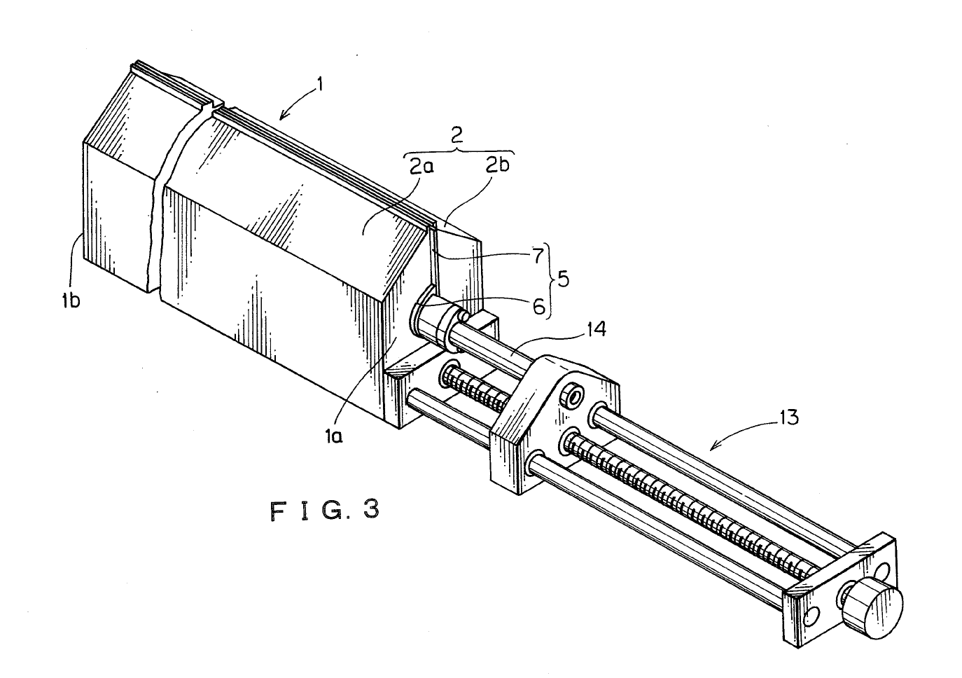

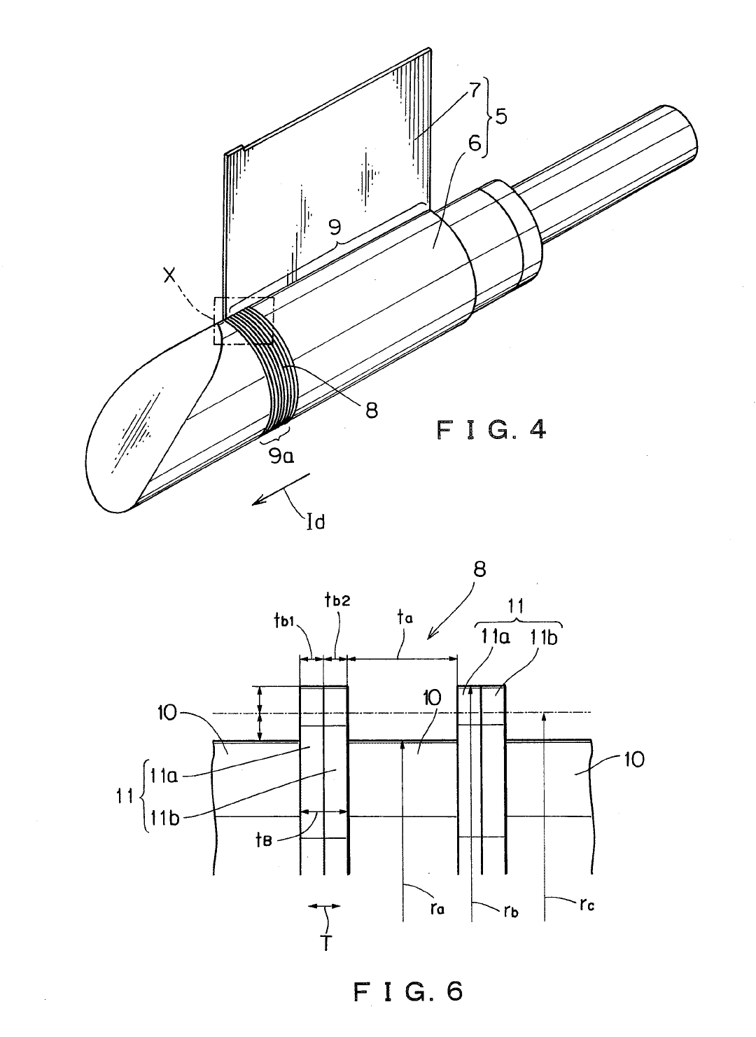

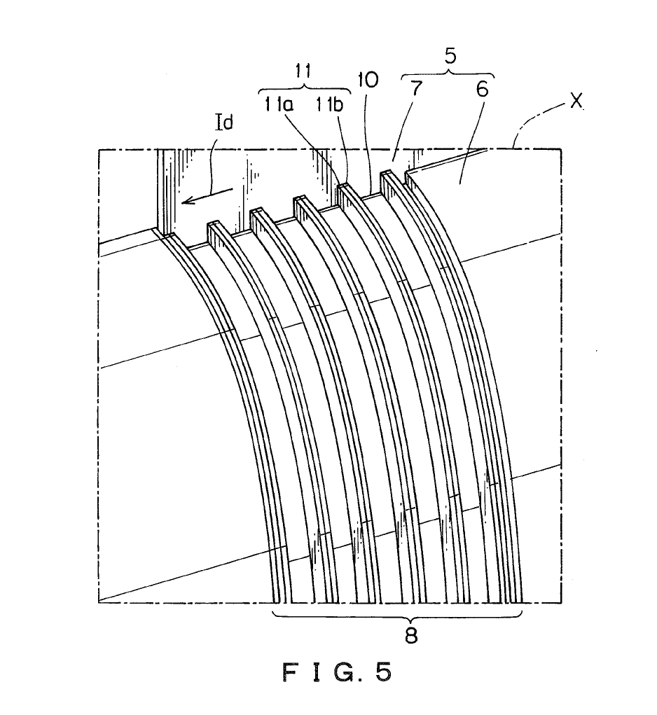

FIG. 2 is a perspective view illustrating a state of a representative inner deckle constituting a die-type coating device according to the present disclosure before being attached to a die. FIG. 3 is a perspective view illustrating a state of the inner deckle shown in FIG. 2 after being attached to a die. FIG. 4 is an enlarged perspective view of the inner deckle shown in FIG. 2, as viewed obliquely from above at the front end side thereof. FIG. 5 is an enlarged perspective view of a part of an inner deckle in region X of FIG. 4. FIG. 6 is an explanatory view of dimensions of a second spacer member and a sealing member, both of which constitute the seal reinforcing portion of the inner deckle shown in FIG. 4.

The die 1 illustrated in FIG. 2 includes a die piece 2 formed by combining a pair of split die piece members 2a and 2b. Also, the die 1 is formed with a manifold 3 extending to penetrate into the die piece 2 in a longitudinal direction L and a slit 4 extending from the manifold 3 radially outward toward a direction R of the die piece 2.

Each of a pair of inner deckles 5 (only one inner deckle is illustrated) is arranged at one of two end portions 1a and 1b of the die 1, respectively, for coating width adjustment.

The inner deckle 5 includes a shaft-shaped deckle main body 6 and a sheet- or film-shaped deckle auxiliary portion 7. A deviation of the thickness of the deckle auxiliary portion 7 is preferably ±2 μm with respect to the width of the slit 4. Further, the deckle auxiliary portion 7 can be configured as a multilayer-type deckle auxiliary portion 7 comprised of a plurality of sheet- or film-shaped thin pieces so as to have a thickness larger than the width of the slit 4.

The deckle main body 6 has an outer surface shape corresponding to the cavity shape of the manifold 3, and the deckle auxiliary portion 7 extends from the deckle main body 6 and has an outer surface shape corresponding to the shape of the space of the slit 4.

The deckle main body 6 of the inner deckle 5 for use in a coating device according to the present disclosure includes the seal reinforcing portion 8 with a specific structure. More specifically, the deckle main body 6 includes the seal reinforcing portion 8 in at least a part of the region 9 where the deckle auxiliary portion 7 has been arranged—i.e., the part illustrated as a front end side area 9a of the inner deckle 5 in FIG. 4. The seal reinforcing portion 8 reinforces liquid-tight sealing of a liquid material for coating or extrusion, wherein the liquid material is supplied into the cavity of the manifold 3. As shown in FIG. 6, the seal reinforcing portion 8 includes at least one sealing member 11 including two or more films. The films slide and are simultaneously elastically deformed against the inner wall of the manifold 3 when the position of the inner deckle 5 moves with respect to the die 1. When the position of the inner deckle 5 is fixed with respect to the die 1, the films cooperate with each other and are closely adhered to the inner wall by an elastic restoring force. In FIG. 5, which is a partially enlarged view of the seal reinforcing portion of FIG. 4, the seal reinforcing portion 8 includes six sealing members 11, each comprised of two films 11a and 11b.

The description “cooperate with each other and are closely adhered to the inner wall by an elastic restoring force” means that the two or more films constituting the sealing member 11 are elastically restored in the same direction so as to cooperate with each other and be closely adhered to the inner wall of the manifold. Specifically, for example, it is preferable in terms of increase in sealability that two or more films overlapping each other are closely adhered to the inner wall of the manifold. Other preferable states for sealability enhancement include the following: the films separated from each other are closely adhered to the inner wall of the manifold; and a liquid material for coating or extrusion penetrates between the films so that the films cooperate with each other in the presence of a layer which is formed on the inner wall portion of the manifold situated between the films and are closely adhered to the inner wall of the manifold.

With the inner deckle 5 according to the present disclosure employing the foregoing configuration, when the position of the inner deckle 5 is changed with respect to the die 1, the sealing member 11 (more specifically, the films 11a and 11b constituting the sealing member 11) of the seal reinforcing portion 8 contacts the inner wall of the manifold 3 of the die 1. However, the sealing member slides and is at the same time easily elastically deformed in the direction opposite to the attachment direction (insertion direction) Id of the inner deckle 5, and the force of inserting the inner deckle 5 into the die 1 can be reduced. Further, when the position of the inner deckle 5 is fixed with respect to the die 1, the sealing members 11 of the seal reinforcing portion 8 cooperate with each other and are closely adhered to the inner wall of the manifold 3 by an elastic restoring force. It is thereby possible to simultaneously ensure a sufficient liquid-tight state when the position of the inner deckle 5 is fixed with respect to the die 1, and the ease of coating width adjustment when the position of the inner deckle 5 is moved with respect to the die 1.

According to the present disclosure, in particular, the seal reinforcing portion 8 includes the sealing member 11 including two or more films 11a and 11b, not a single film. Therefore, when the position of the inner deckle 5 is moved with respect to the die 1, the falling deformation of the films 11a and 11b can be further facilitated to increase the slidability. Further, when the position of the inner deckle 5 is fixed with respect to the die 1, the films 11a and 11b of the sealing member 11 on the inner wall of the manifold 3 of the die 1 should be in a state of cooperating with each other, preferably in a state of being overlapped with each other, by an elastic restoring force. When the films 11a and 11b are closely adhered to the inner wall of the manifold 3 in the aforementioned state, the total area of contact between the films 11a and 11b and the inner wall can be increased compared with a sealing member formed of a single film, thereby ensuring a sufficient liquid-tight state.

The films 11a and 11b constituting the sealing member 11 are required to have an outer diameter rb larger than a manifold diameter rc so that when the position of the inner deckle 5 is fixed with respect to the die 1, the films 11a and 11b cooperate with each other and are closely adhered to the inner wall of the manifold 3 by an elastic reinforcing force. Specifically, it is preferable that the outer diameter rb of the films 11a and 11b constituting the sealing member 11 is larger than the manifold diameter rc by 0.01 to 1 mm. The term “manifold diameter” means a radius when the cross-sectional shape of the manifold 3 is a perfect circle shape. Further, when the cross-section of the manifold 3 has a shape with a plurality of different diameters like a semicircular shape as shown in FIG. 1, a semi-elliptical shape, or an elliptical shape, the term “manifold diameter” means a radius (half of the diameter) measured from a central position of the diameter or a position equivalent thereto along the direction in which the slit 4 extends (radially outward toward the direction R of the die piece 2 shown in FIG. 1).

When the outer diameter rb of the films 11a and 11b constituting the sealing member 11 is larger than the manifold diameter rc by 1 mm or more, the force required for inserting the inner deckle 5 increases when the position of the inner deckle 5 is moved with respect to the die 1. This is not preferable since the workability during the attachment tends to be degraded. Further, it is not preferable that the outer diameter rb of the films 11a and 11b is larger than the manifold diameter rc by only less than 0.01 mm since there is a tendency that a sufficient liquid-tight state cannot be ensured when the position of the inner deckle 5 is fixed with respect to the die 1.

The films 11a and 11b constituting the sealing member 11 are required to be readily capable of falling deformation when the position of the inner deckle 5 is changed with respect to the die 1. The films 11a and 11b are required to have their shapes restored to the original when the position of the inner deckle 5 is fixed with respect to the die 1. The films should be made of an elastic material with a modulus of elasticity of 10000 MPa or less, preferably 1000 MPa or less. In particular, a lubricating resin material is most preferable.

The lubricating resin material is not particularly limited, but it is preferable that the sealing member 11 has excellent chemical resistance and slidability. In this regard, as the lubricating resin material, it is preferable to use a resin material with a coefficient of static friction of 0.2 or less, e.g., polytetrafluoroethylene (PTFE).

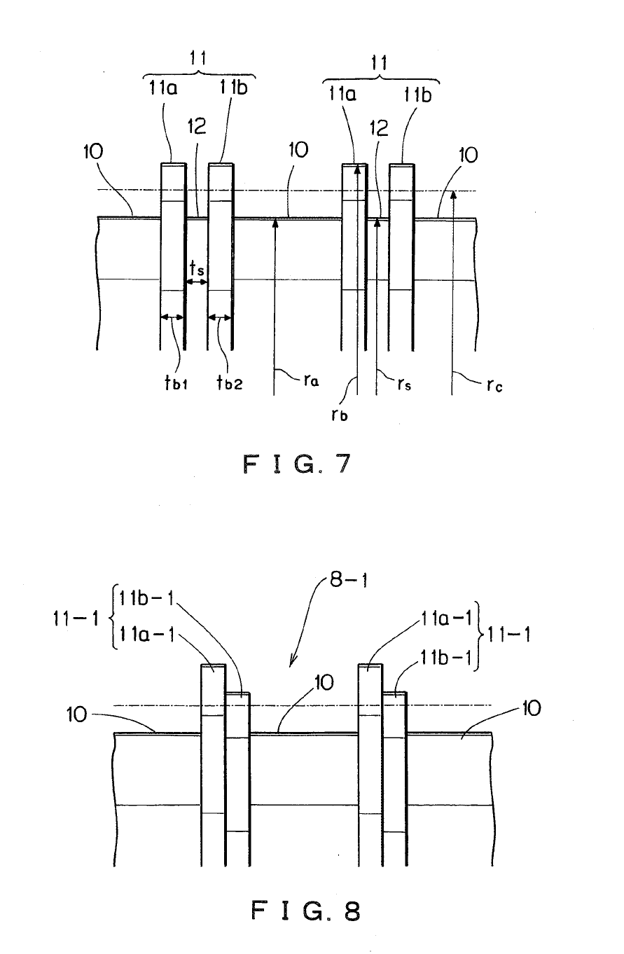

Further, FIGS. 4 and 5 show the sealing member 11 including only two films 11a and 11b. However, the sealing member 11 may include three or more films. Further, as long as the overlapping state of the films can be retained when the position of the inner deckle 5 is fixed with respect to the die 1, a first spacer member 12 may be further included between the film 11a and the film 11b as shown, for example, in FIG. 7. The first spacer member 12 should have an outer diameter rs smaller than the manifold diameter rc, preferably smaller by 0.001 to 3 mm. The first spacer member 12 may be properly formed, as necessary.

Further, when the first spacer member 12 is formed, the thickness ts of the first spacer member 12 preferably satisfies the following equation:

ts<(rb−rs)

where:

rs denotes the outer diameter of the first spacer member 12; and

rb denotes the outer diameter of the films 11a and 11b.

When ts (rb−rs) holds true, the distance between the films 11a and 11b is equal to or larger than the length of the elastically deformed part of the films 11a and 11b. Therefore, the films 11a and 11b are separated from each other when the position of the inner deckle 5 is fixed with respect to the die 1. This is not preferable since there is a tendency that the state of the two films cooperating with each other, particularly the state of overlapping with each other, cannot be achieved.

Further, the thickness tb (in FIG. 6, tb1 and tb2) of the films 11a and 11b is only required to be set such that the films 11a and 11b slide and are simultaneously elastically deformed against the inner wall of the manifold when the position of the inner deckle is moved with respect to the die. In the above setting, the films 11a and 11b should cooperate with each other and be closely adhered to the inner wall by an elastic restoring force when the position of the inner deckle is fixed with respect to the die. Although not particularly limited, when the position of the inner deckle is moved with respect to the die, the thickness tb of each film 11a, 11b that can slide and is simultaneously elastically deformed against the inner wall of the manifold is preferably within the range of, for example, tb 4 (rc−rs). In the case of tb>4 (rc−rs), there is a tendency that the moving force required for sliding increases and that the inner deckle cannot move inside the die. One reason is that the films 11a and 11b cannot be sufficiently elastically deformed against the inner wall of the manifold when the position of the inner deckle is moved with respect to the die.

The preferable range of the thickness of the films 11a and 11b varies with the material of the films. However, for example, when a PTFE film is used as the films 11a and 11b, the thickness of each film 11a, 11b is preferably about 0.05 to 0.4 mm.

Further, the seal reinforcing portion 8 includes at least two sealing members 11. In FIG. 4, the seal reinforcing portion 8 includes six sealing members 11. It is preferable that the second spacer member 10 having an outer diameter ra, which is smaller than the manifold diameter rc, is further formed between the sealing members 11 and 11. One reason is that it is possible to secure a space where the films 11a and 11b constituting the sealing member 11 are elastically deformed when the position of the inner deckle 5 is moved. Another reason is that the area of contact between the entire inner deckle 5 and the inner wall of the manifold 3 of the die is reduced, thereby reducing the sliding resistance.

Further, in the example shown in FIG. 4, six sealing members 11 are provided, and five second spacer members 10 are interposed between the sealing members 11. However, the numbers of the sealing members 11 and the second spacer members 10 can be properly selected, as necessary.

It is preferable that the outer diameter ra of the second spacer member 10 is smaller than the manifold diameter by 0.001 to 3 mm. When the outer diameter ra of the second spacer member 10 is smaller than the manifold diameter rc by 3 mm or more, a large space is produced between the second spacer member 10 and the inner wall of the manifold 3 of the die 1 when the inner deckle 5 is attached to the die 1. There is a tendency that a sufficient liquid-tight state cannot be ensured when the position of the inner deckle 5 is fixed. Further, when the outer diameter ra of the second spacer member 10 is smaller than the manifold diameter rc by less than 0.001 mm, there is a tendency that the force required for moving the inner deckle 5 increases during the movement of the position (during the attachment). One reason is lack of space in the manifold 3 of the die 1 where the sealing member 11 of the seal reinforcing portion 8 deforms toward the second spacer member 10 when the position of the inner deckle 5 is moved.

The material of the first spacer member 12 and the second spacer member 10 is not particularly limited; however, for example, various resin materials, such as polyethylene terephthalate (PET) and PTFE, may be used.

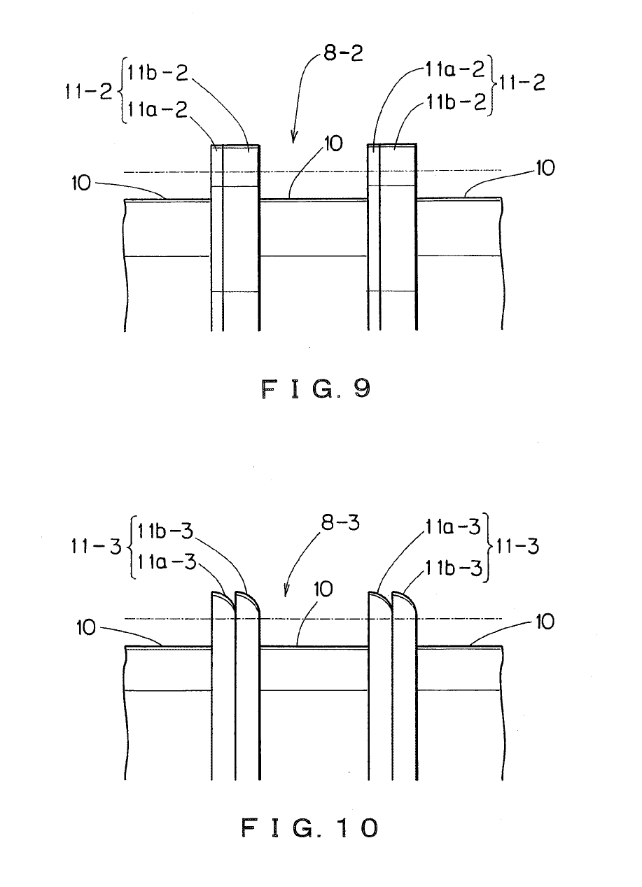

Further, FIGS. 8 to 10 show a sealing member 11 constituting a seal reinforcing portion 8 according to another embodiment. FIG. 8 shows that the two films 11a and 11b constituting the sealing member have a different outer diameter. FIG. 9 shows that the two films 11a and 11b constituting the sealing member 11 have a different thickness. FIG. 10 shows that the cross-section of the outer edge portion of the two films 11a and 11b constituting the sealing member 11 is so shaped that the area of contact between the inner wall of the manifold 3 and the die 1 increases when the inner deckle 5 is attached to the die 1. Further, it is possible to combine these configurations.

Further, the inner deckle 5 according to the present disclosure is an inner deckle for a die. The die 1 including the inner deckle 5 simultaneously ensures a sufficient liquid-tight state and the ease of coating width adjustment.

Next, an example of a die-type coating method according to the present disclosure will be described below.

First, a long belt-shaped web T is continuously conveyed from the supply roll 20, and both widthwise end positions 30a and 30b of the conveyed web T are detected by a pair of web widthwise end position detection means 28 and 28 which are arranged above both widthwise end positions 30a and 30b of the web T.

Then, a coating liquid is discharged from the die 21 onto at least one surface of the web T, which is illustrated as one surface Ta of the web T in FIG. 1, so as to form a coating liquid layer 23.

Then, both widthwise end positions 31a and 31b of the coating liquid layer 23 are detected by a pair of layer widthwise end position detection means 29 and 29.

Then, output signals of information on both widthwise end positions 30a and 30b of the web T detected by the web widthwise end position detection means 28 and 28 and information on both widthwise end positions 31a and 31b of the coating liquid layer 23 detected by the layer widthwise end position detection means 29 and 29 are input into a control device 33. When the web is conveyed at a position displaced from the normal conveyance position, a drive means 32 is driven on the basis of these output signals. The respective positions of the inner deckles 35 relative to the die 21 are changed so that both widthwise end positions of the coating liquid layer formed on the surface of the web are quickly corrected to have a desired position relative to both widthwise end positions of the web.

Then, the rewinding roll rewinds the web T after the web T is passed through and is dried by the drying device 25 to form a coating layer.

In this way, with the coating device and the coating method according to the present disclosure, the coating layer 24 can be accurately formed at an intended central widthwise position of the web T over the entire length of the wound web T. Thereafter, in the web T provided with the coating layer 24, it is possible to reduce the cut-off width at both widthwise end portions where the coating layer is not formed. As a result, the amount of industrial waste can be reduced, thereby improving the yield. Further, when a workpiece is changed to a web having a different width to form a coating layer, the coating width can be flexibly adjusted with respect to the web width without the die having to be disassembled. As a result, the cost for die installation and man-hours required for assembling the die can be reduced.

An inner deckle for a die for use in the coating device of the present disclosure has a configuration for simultaneously ensuring a sufficient liquid-tight state and the ease of coating width adjustment. In particular, even if a coating liquid with a low viscosity is applied, the coating device according to the present disclosure can provide a remarkable effect that the coating width can be easily adjusted while retaining a sufficient liquid-tight state.

The above description merely shows one example embodiment of the present disclosure, and various modifications can be added according to the descriptions of the claims.

### Example

Next, a coating device according to the present disclosure was prototyped. A performance test was conducted using this prototype coating device to continuously perform coating on the surface of a running web. The description is provided below.

In the Example, the coating device shown in FIG. 1, the die shown in FIGS. 2 and 3, and the inner deckle shown in FIGS. 2 to 6 were used. The manifold diameter rc of the die 1 was 20 mm, the width of the slit 4 was 300 and the thickness of the deckle auxiliary portion 7 was 295 μm. The seal reinforcing portion 8 was formed on a front end side area 9a of the inner deckle within the region where the deckle auxiliary portion 7 was arranged. The seal reinforcing portion 8 included the following: a total of six sealing members 11, each comprised of two films 11a and 11b of PTFE resin material having a thickness of 200 μm; and a total of five second spacer members 10 which were interposed between the sealing members 11 and 11 and made of PET resin having a thickness of 500 μm. The outer diameter ra of the second spacer member 10 was set to be smaller than the manifold diameter rc by 100 μm, and the outer diameter rb of the two films 11a and 11b constituting the sealing member 11 was set to be larger than the manifold diameter rc by 100 μm. While the coating liquid was applied to the surface of a continuously running web, the web widthwise end position detection means and the layer widthwise end position detection means detected both widthwise end positions of the web T and both widthwise end positions of the coating liquid layer, respectively. As a result of the detection, when the web was determined as being conveyed at a position displaced from the normal conveyance position, the drive device was driven on the basis of the results of the detection by the control device. The position of the inner deckle was moved in the die and the coating liquid was applied to the web over the entire length thereof such that the coating liquid layer was controlled to be applied to a predetermined position of the web. An acrylic adhesive (viscosity: 100 mPas) was used as the coating liquid, and the coating conditions were adjusted so that the coating width after drying became 200 μm

A PET film having a thickness of 38 μm and a width of 250 mm was used as the web and passed through the coating device. The running web was made to meander across a swing width of 5 mm by means of an EPC (edge position control) device. When the coating width was extended to its maximum extent, a region with a coating thickness of 200±20 μm was registered as a region with a maximum coating width (mm).

For comparison, a coating layer was formed on the surface of a web in the same manner as in the Example except the following: the web widthwise end position detection means, the layer widthwise end position detection means, the drive device, and the control device were not provided; and the inner deckle arranged on the die was not moved but retained at a fixed position during the application of the coating liquid to the web.

Table 1 shows results of measurements of the maximum coating widths of the webs with the coating layers produced according to the Example and the Comparative Example.

TABLE 1

| | Max. coating width (mm) |
|---|---|
| | (Web width: 250 mm) |
| Comparative Example | 236 |
| Example | 249 |

According to the test results shown in Table 1, the maximum coating width of the Example is wider than that of the Comparative Example. Therefore, it will be appreciated that both widthwise end positions of the coating layer were quickly corrected to have a proper position relative to both widthwise end positions of the web.

Further, with the coating device according to the present disclosure and the same coating method as above, a coating layer was formed by changing a workpiece (web) from a PET film having a width of 250 mm to a PET film having a width of 200 mm. As a result, it was confirmed that without the die having to be disassembled, the inner deckle was moved by a slight insertion force and an appropriate coating width was quickly set in response to a change in the web width.

### INDUSTRIAL APPLICABILITY

According to the present disclosure, it has become possible to provide a die-type coating device and a die-type coating method characterized in that: inner deckles, each of which is arranged at one of the two end portions of a die, are configured to be easily moved in the die in the longitudinal direction of the die; predetermined detection means are arranged upstream and downstream of the die, respectively, in the conveyance direction of a web; thereby, even if a continuously running, long belt-shaped web is conveyed at a position displaced from the normal conveyance position, both widthwise end positions of a coating liquid layer or a coating layer formed on the surface of the web are quickly corrected to have a desired position relative to both widthwise end positions of the web; and even if a workpiece is changed to a web having a different width to form a coating layer, the coating width can be easily adjusted with respect to the web width without the die having to be disassembled.

1. A die-type coating device, comprising:
a supply roll which continuously conveys a long belt-shaped web;
a die which discharges and thereby applies a coating liquid to at least one surface of the web conveyed from the supply roll;
a rewinding roll which rewinds the web after a layer of the coating liquid discharged and thereby applied to the web is dried and turned into a coating layer;
web widthwise end position detection means which are arranged upstream of the die in a conveyance direction of the web to detect both widthwise end positions of the web; and
layer widthwise end position detection means which are arranged downstream of the die in the conveyance direction of the web to detect both widthwise end positions of the layer of the coating liquid or the coating layer on the web,
the die including:
a pair of inner deckles which adjust a coating width, wherein the inner deckle is arranged at one of two end portions of the die and configured to be easily moved in the die in a longitudinal direction of the die; and
a drive means which drives and thereby moves the inner deckles,
wherein
the drive means is driven on a basis of information on the both widthwise end positions of the web detected by the web widthwise end position detection means and information on the both widthwise end positions of the layer of the coating liquid or the coating layer detected by the layer widthwise end position detection means so that respective positions of the inner deckles relative to the die are changed.

2. The die-type coating device according to claim 1, wherein
the die further includes a die piece formed by combining a pair of split die piece members, the die being formed with a manifold extending in a longitudinal direction of the die piece and a slit extending from the manifold radially outward toward the direction of the die piece,
the inner deckle includes a shaft-shaped deckle main body having an outer surface shape corresponding to a shape of the manifold and a sheet- or film-shaped deckle auxiliary portion which extends from the deckle main body and has an outer surface shape corresponding to a shape of the slit,
the deckle main body includes, in at least a part of a region where the deckle auxiliary portion is arranged, a seal reinforcing portion for reinforcing liquid-tight sealing of a liquid material for coating or extrusion, wherein the liquid material is supplied into the manifold, and
the seal reinforcing portion includes at least one sealing member including two or more films; the films slide and are simultaneously elastically deformed against an inner wall of the manifold when a position of the inner deckle is moved with respect to the die; and the films cooperate with each other and are closely adhered to the inner wall by an elastic restoring force when the position of the inner deckle is fixed with respect to the die.

3. The die-type coating device according to claim 1, wherein the film constituting the sealing member has an outer diameter larger than a manifold diameter (rc).

4. The die-type coating device according to claim 1, wherein an outer diameter (rb) of the film constituting the sealing member is larger than the manifold diameter (rc) by 0.01 to 1 mm.

5. The die-type coating device according to claim 1, wherein each sealing member further includes, between the films, a first spacer member having an outer diameter (rs) smaller than the manifold diameter (rc).

6. The die-type coating device according to claim 1, wherein the outer diameter (rs) of the first spacer member is smaller than the manifold diameter (rc) by 0.001 to 3 mm.

7. The die-type coating device according to claim 1, wherein, a thickness ts of the first spacer member satisfies an equation below:
ts<(rb−rs)
where: rs denotes the outer diameter of the first spacer member; and
rb denotes the outer diameter of the film.

8. The die-type coating device according to claim 1, wherein the seal reinforcing portion includes at least two sealing members and further includes, between the sealing members, a second spacer member having an outer diameter (ra) smaller than the manifold diameter (rc).

9. The die-type coating device according to claim 1, wherein the outer diameter (ra) of the second spacer member is smaller than the manifold diameter by 0.001 to 3 mm.

10. The die-type coating device according to claim 1, wherein the seal reinforcing portion is formed on a front end side area of the inner deckle within a region where the deckle auxiliary portion is arranged.

11. The die-type coating device according to claim 1, wherein a number of films constituting each sealing member is two.

12. The die-type coating device according to claim 1, wherein the film is made of a lubricating resin material.

13. A die-type coating method comprising the steps of:
continuously conveying a long belt-shaped web from a supply roll;
discharging and thereby applying a coating liquid by means of a die to at least one surface of the web conveyed;
rewinding the web by means of a rewinding roll after a layer of the coating liquid discharged and thereby applied to the web is dried and turned into a coating layer;
detecting both widthwise end positions of the web by means of web widthwise end position detection means arranged upstream of the die in a conveyance direction of the web; and
detecting both widthwise end positions of the layer of the coating liquid or the coating layer on the web by means of layer widthwise end position detection means arranged downstream of the die in the conveyance direction of the web,
the die including:
a pair of inner deckles which adjust a coating width, wherein the inner deckle is arranged at one of two end portions of the die and configured to be easily moved in the die in a longitudinal direction of the die; and
a drive means which drives and thereby moves the inner deckles,
wherein
the drive means is driven on a basis of information on the both widthwise end positions of the web detected by the web widthwise end position detection means and information on the both widthwise end positions of the layer of the coating liquid or the coating layer detected by the layer widthwise end position detection means so that respective positions of the inner deckles relative to the die are changed.
